(19) United States
(12) Patent Application Publication
(10) Pub. No.: US 2006/0112746 A1
(43) Pub. Date: Jun. 1, 2006

(54) Electric lock device with manual redundancy

(76) Inventor: Kenneth Thompson, Mulino, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 10/997,964

(22) Filed: Nov. 29, 2004

(51) Int. Cl. E05B 65/12

(52) U.S. Cl. 70/257

(57) ABSTRACT

An electric lock operating in conjunction with a wireless remote transmitter and having redundant manual operation capability. The key lock cylinder has a three way position. In the remote position, the lock is enabled or disabled via a remote wireless transmitter. Operation of the wireless transmitter switch allows electric power to a micro switch that allows electricity to drive open a mechanical latch when a circuit is completed touching a pushbutton switch. In a manual lock position, the electronic function of the lock are disabled by mechanical discontinuity of a circuit preventing the latch from being opened either by electrical or mechanical operation. Turning the key in the lock cylinder to the manual open position will mechanically actuate the latch to open through a linkage system.

### CROSS-REFERENCE TO RELATED APPLICATIONS

This application is related to application Ser. No. 10/286,690.

### BACKGROUND OF THE INVENTION

The present invention relates to a locking device which may be electrically operated in conjunction with a remote transmitter, while also having the capability of independent manual operation.

Pickup truck owners lack a secure area for storing tools and equipment, and one solution for this problem is a lockable, bed mounted storage box. The drawback of some of these existing boxes is that they do not utilize the electronic locking systems incorporated into most modern vehicles, and they do not permit remote operation. Rather, the owner who wants to permit other workers to access the box must either surrender the key or leave his work to accompany the worker to the box to unlock and relock it.

### BRIEF SUMMARY OF THE INVENTION

An electric lock with manual redundancy for operation in conjunction with a vehicle's electronic locking system, and the method of operation.

### BRIEF DESCRIPTION OF THE SEVERAL DRAWINGS

FIG. 1 is a diagram of the electrical schematics of the device.

FIG. 2 is a top view of the device.

FIG. 3 is a perspective view of the front of the device.

FIG. 4 is a top view of the device in manual open position.

FIG. 5 is a perspective view of the back of the device in the manual open position.

FIG. 6 is a top view of the device in the remote position.

FIG. 7 is a perspective view of the device in the remote position.

FIG. 8 is a perspective view of the device in the manual locked position.

### DETAILED DESCRIPTION

The device comprises an electric lock for operation with a wireless transmitter with the ability both to lock the device remotely and to set the device remotely for keyless electric opening. Some embodiments of the present invention provide an electrical locking device capable of being operated with a motor vehicle's existing remote keyless entry transmitter system, so an owner need not carry separate transmitters for a vehicle's locks.

An owner need not surrender his key or wireless transmitter to permit another worker to open the device.

Some embodiments of the present invention comprise a redundancy feature which allows an owner to use a key to lock the device manually to override any remote operation, and to use a key to manually open the device. A power failure of the wireless transmitter or electric lock mechanism will not prohibit an owner from opening the device. Rather, in the event of failures such as loss of electric power, transmitter system malfunction or electric driver failure, an owner may still operate the lock by using a redundant manual mechanical system.

The present device comprises a lock mechanism 2 having a key 4. The key may be inserted and turned in a lock barrel 6 into a manual lock position 94, a manual open position 12, and a remote position 8.

When the key 4 in either manual lock position 94 or manual open position 12, the lock mechanism 2 manually locks or unlocks the device respectively.

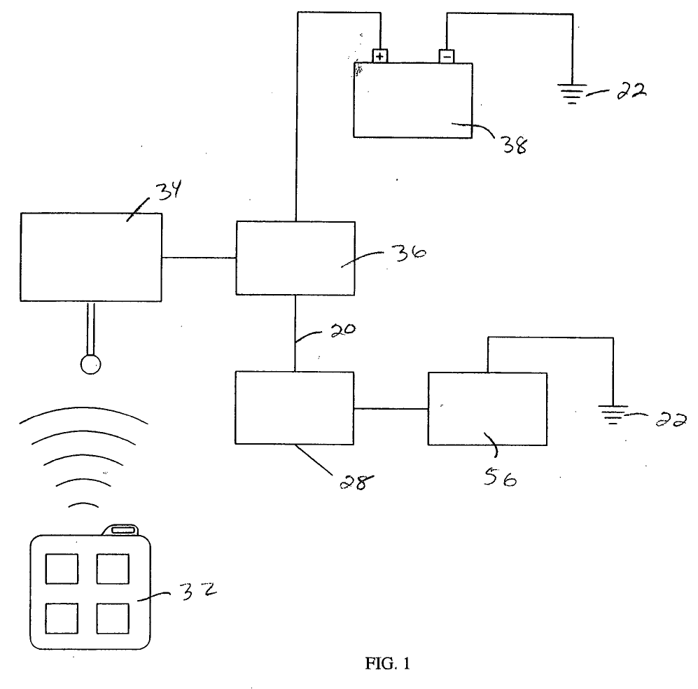

When the key 4 is in remote position 8, the device is ready for remote operation. FIG. 1 is a diagram showing an electrical schematic of the device illustrating its remote operation. A wireless transmitter 32 sends a signal (not shown) to a transmitter receiver 34. The receiver 34 is electrically connected to a relay 36. The relay 36 sends an operational signal (not shown) to micro switch 28. Relay 36 is shown with chassis ground 22 and battery 38.

An owner activates the keyless entry system of the vehicle to lock the vehicle's doors thereby sending a non-conditioning signal to relay switch 36. This prevents any electrical operation of the lock device. However, turning key 4 in lock mechanism 2 to manual open position 12 will trip latch module 14 and open truck box lid 16. Turning key 4 to the manual lock position 94 will prevent the lock mechanism 2 from opening by preventing latch module 14 from being tripped even if there is a conditioning signal sent to relay switch 36.

When the owner activates the keyless entry system to unlock the vehicle's doors, a conditioning signal is sent to relay switch 36. An operator, either the owner or another person, can open the truck box lid 16 by pushing a pushbutton switch 18 incorporated into switch 28, completing a circuit 20 between switch 28 and a chassis ground 22. Switch 28 momentarily provides electrical power to linear actuators 26 and 46 to move return push rods 97 and 98, to trip latch module 14 and open truck box lid 16.

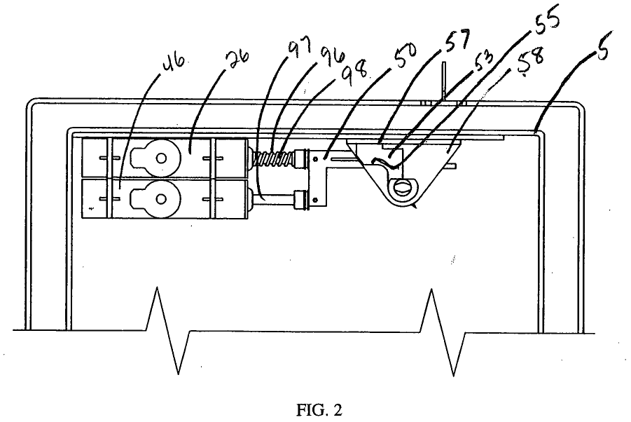

FIGS. 2-6 illustrate the mechanical operation of the some embodiments of the present invention. Key 4 is insertable into a matingly receptive key shaft 40 in barrel lock assembly 2 in the remote position 8. Key 4 may be rotated counter-clockwise approximately 90 degrees from the remote position 8 to the manual lock position 94, preventing further key shaft 40 rotation if key 4 is removed. Key 4 can also be rotated approximately 90 degrees clockwise from the remote position 8 to the manual open position 12.

A latch activating arm 44 rotates coaxially with rotation of the key 4.

When key 4 is in the manual lock position 94, latch activating arm 44 has been rotated where it cannot engage either manually or electrically with the latch linkage 93.

When key 4 is turned to the manual open position 12, arm 44 has been rotated clockwise coaxially with key 4. This causes arm 44 to manually drive latch linkage 93 to slide within linkage slide connector 95 to slide linkage 50 such that lock pin 52 is released. Lock pin 52 is fixed to latch stop 53 and projects vertically between latch stop 53 and lock strike 54 when the truck bed lid 16 is closed. Sliding of linkage slide connector 95 turns latch stop 53 causing lock pin 52 to release lock strike 54, unlocking the truck bed lid.

With key 4 in the remote position 8, latch module 14 can be triggered to open electrically. In the remote position key shaft 40 holds latch activating arm 44 in a vertical orientation. When switch 28 is conditioned by a conditioning signal (not shown) from transmitter receiver 34 and push button switch 18 is operated, power is provided to linear actuator 26 and 46. Linear actuator 26 and 46 overcomes a return spring 96 and retracts pushrods 97 and 98. Pushrods 97 and 98 retract linkage 50, thereby pulling linkage slide connector 95, thus turning lock pin 52 and releasing lock strike 54. When power is no longer provided to linear actuator 26 and 46, return spring 96 forces pushrods 97 and 98 back to a extended configuration.

When key 4 is in remote position 8 but in the absence of the conditioning signal, operation of push button switch 18 cannot provide sufficient current (not shown) or complete circuit 20. Return spring 96 maintains pushrods 97 and 98 in the extended position and correspondingly, the lock pin 52 remains unrotateable.

In some embodiments of the present invention, switch 28 provides a pulsed 12 volt signal through solenoid 56 to linear actuator 26 and 46.

Lock pin 52 is fixedly attached to latch stop 53. Latch stop 53 abuts arm 44 when the device is in the remote position 8 on a side 55 of the latch stop. The opposite side 57 of the latch stop 53 abuts interior truck box surface 5 to halt the rotation of lock pin 52.

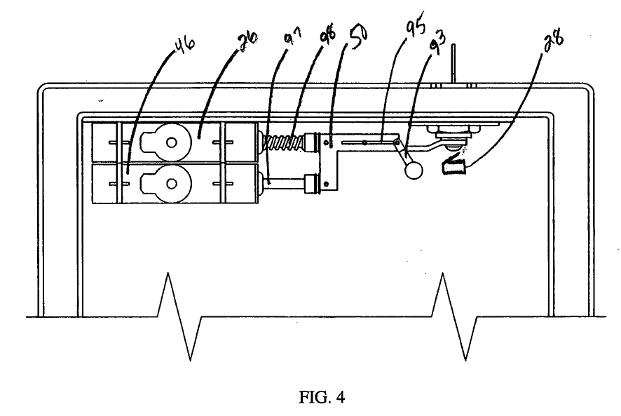

As FIG. 2, a top view of the device, illustrates, a bracket 58 supports latch stop 53, which is glidingly attached to linkage slide connector 95 by latch linkage 93 (shown on FIG. 4) with connector 50. The latch actuators 26 and 46 further comprise pushrods 97 and 98 respectively. Latch actuator 26 further comprises return spring 96. Lock pin 52 and latch activating arm 44 are capable of coaxial rotation, and are mounted with bracket 58 to align with lock strike 54 (not shown) in either the remote position 8 or the manual lock position 94.

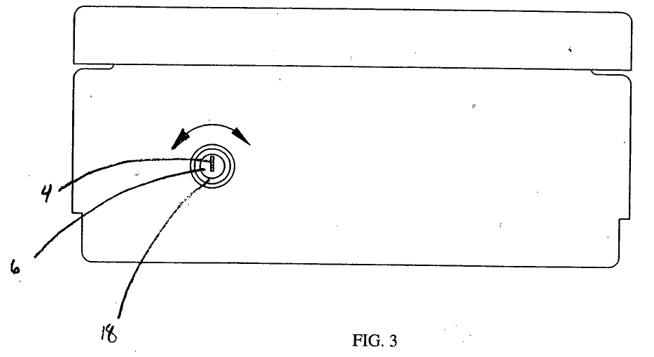

As FIG. 3, a perspective view of the front of the device, illustrates, lock barrel 6 is matingly receptive for key 4 (not shown) and the key is capable of rotation between an approximately vertical remote position 8 and manual lock or open positions 94 and 12 at approximately quarter turns counterclockwise and clockwise respectively. As can be seen from this description, some embodiment the present invention may comprise a lock mechanism orientation which places the remote position 8 at an orientation other than vertical and permits relative rotation to the other positions 94 and 12.

As FIG. 4, a top view of the device in manual open position 12, illustrates, key 4 has been inserted into barrel lock 6 and rotated clockwise from the remote position 8 turning latch activating arm 44 such that it moves latch stop 53 and linkage 95, while simultaneously turning lock pin 52, thereby releasing it from lock strike 54.

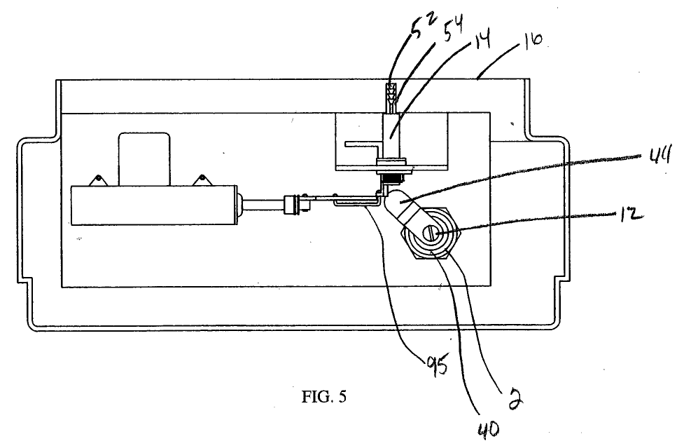

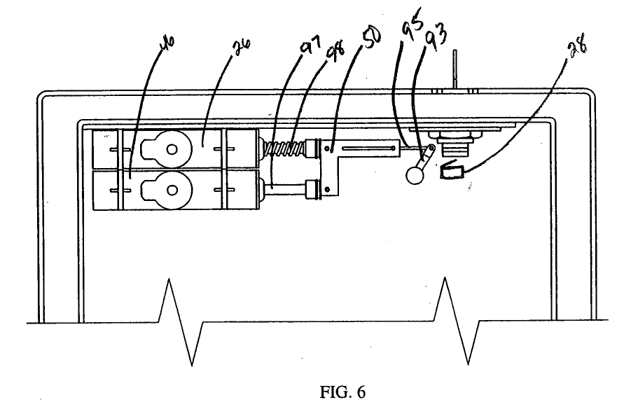

As FIG. 5, a perspective view of the back of the device in the remote position, illustrates, key shaft 40 places latch activating arm in proximity to switch 8 (seen in FIG. 6) which comprises the incorporated push button switch 18. In this configuration linear actuator 26 and 46 can retract pushrods 97 and 98 causing activating arm 44 to move linkage 50 thereby releasing lock pin 52.

FIG. 6 is a top view of the device in the remote position, illustrated without the bracket 58 and without latch stop 53 to show the slidingly mated relationship of the linkage 50, linkage slide connector 95, and latch linkage 93. Latch linkage 93 is capable of pulling on the latch stop 53 causing latch stop 53 to rotate, thereby driving the rotation of lock pin 52.

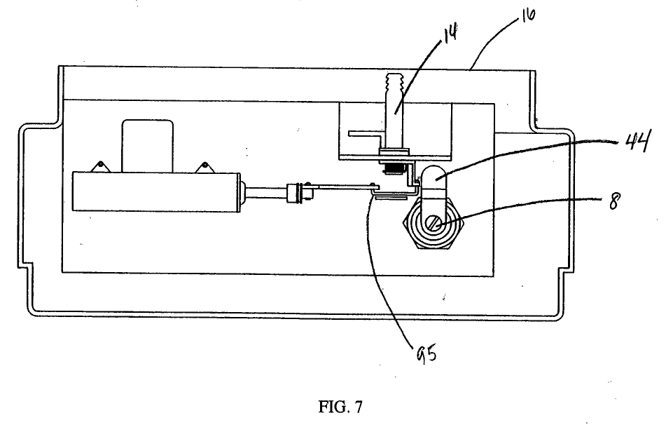

FIG. 7 is a perspective view of the device in the remote position 8. Latch activating arm 44 is capable of contact with switch 28.

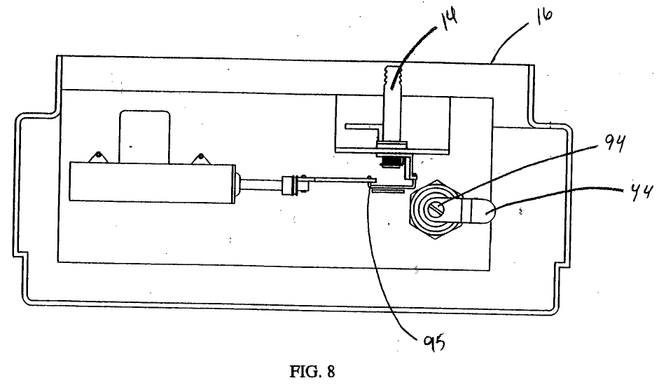

FIG. 8 is a perspective view of the device in the manual lock position 94. Rotation of key 4 to the manual lock position 94 moves the latch activating arm 44 out of range of contact with switch 28. This prevents electrical operation of the lock and provides manual lock override of the device for additional security.

In some embodiments of the present invention, latch module 14 is a “slam” latch which is well know in the industry. Substitution of other types of latches compatible with the other components of this invention would be well know to one skilled in the art.

The terms and expressions which have been employed in the forgoing specification are used therein as terms of description and not of limitation, and there is no intention in the use of such terms and expressions of excluding equivalence of the features shown and described or portions thereof, it being recognized that the scope of the invention is defined and limited only by the claims which follow.

I claim:

1. An electric lock comprising:
a. an electric switch adapted to provide electricity to a linear actuator;
b. linear actuator engaged to a latch actuator;
c. a latch actuator, adapted to transfer linear motion from said linear actuator to rotary motion of said latch actuator;
d. a latch; and
e. a wireless transmitter and a receiver adapted to provide electricity to said electric switch in response to signals generated by said wireless transmitter receiver unit.

2. The electric lock of claim 1 wherein said linear actuator further comprises;
a. a return spring; and
b. a push rod adapted to provide linear motion in response to movement by said latch actuator.

3. The electric lock of claim 1 wherein said linear actuator further comprises:
a. an electric solenoid; and
b. a push rod adapted to provide linear motion in response to a signal by said electric solenoid.

4. The electric lock of claim 1 wherein said electric switch is adapted to provide electrical continuity in response to a manual movement of an external switch.

5. The electric lock of claim 4 wherein said external switch comprises a push button.

6. The electric lock of claim 1 wherein said latch is a slam latch.

7. The electric lock of claim 1 wherein said transmitter is a vehicular keyless entry system.

8. The electric lock of claim 1 wherein said latch actuator further comprises
a. a housing bracket;
b. a mechanical linkage, said mechanical linkage operatively connected to said latch, said push rod, and said return spring; and
c. a lock pin.

9. An electric lock comprising:
a. an electric push button switch adapted to provide electricity to a linear actuator and adapted to provide electrical continuity in response to a manual movement of said switch;
b. a slam latch with a matingly aligned lock pin;
c. a linear actuator comprising a return spring, push rod, and electric solenoid, and where said linear actuator is engaged to a latch actuator, where said a latch actuator is adapted to transfer linear motion from said linear actuator to rotary motion of said latch actuator, and where a return spring; and
d. a push rod adapted to provide linear motion in response to a signal by said solenoid;
e. where said latch actuator comprises a housing bracket, a mechanical linkage, operatively connected to said latch, said push rod, and said return spring; and
f. a vehicular keyless entry system wireless transmitter and a receiver adapted to provide electricity to an electric switch in response to signals generated by said wireless transmitter receiver unit.

10. The method of providing an electric lock comprising the step of providing:
a. an electric switch adapted to provide electricity to a linear actuator;
b. linear actuator engaged to a latch actuator;
c. a latch actuator, adapted to transfer linear motion from said linear actuator to rotary motion of said latch actuator;
d. a latch; and
e. a wireless transmitter and a receiver adapted to provide electricity to said electric switch in response to signals generated by said wireless transmitter receiver unit.

11. The method of claim 10 wherein said linear actuator further comprises;
a. a return spring; and
b. a push rod adapted to provide linear motion in response to movement by said latch actuator.

12. The method of claim 10 wherein said linear actuator-further comprises:
a. an electric solenoid; and
b. a push rod adapted to provide linear motion in response to a signal by said electric solenoid.

13. The method of claim 1 wherein said electric switch is adapted to provide electrical continuity in response to a manual movement of an external switch.

14. The method of claim 13 wherein said external switch comprises a push button.

15. The method of claim 10 wherein said latch is a slam latch.

16. The method of claim 10 wherein said transmitter is a vehicular keyless entry system.

17. The method of claim 10 wherein said latch actuator further comprises
a. a housing bracket;
b. a mechanical linkage, said mechanical linkage operatively connected to said latch, said push rod, and said return spring; and
c. a lock pin.

18. The method of providing a lock, comprising
a. providing an electric push button switch adapted to provide electricity to a linear actuator and adapted to provide electrical continuity in response to a mechanical movement of said electric switch; a slam latch with a matingly aligned a lock pin; a linear actuator comprising a return spring, a push rod, an electric solenoid, and where said linear actuator is engaged to a latch actuator, where said a latch actuator is adapted to transfer linear motion from said linear actuator to rotary motion of said latch actuator, and where said latch actuator comprises a housing bracket and a mechanical linkage operatively connected to said latch, said push rod, and said return spring; and said push rod adapted to provide linear motion in response to movement by said electric motor; and a vehicular keyless entry system wireless transmitter and a receiver adapted to provide electricity to said electric switch in response to signals generated by said wireless transmitter receiver unit;
b. providing said a conditioning signal to said receiver by said transmitter;
c. engaging said electric switch to signal said linear actuator to disengage said lock pin from said latch; and
d. providing a non-conditioning signal to said receiver by said transmitter to un-condition said switch.
